(19) United States
(12) Patent Application Publication
(10) Pub. No.: US 2010/0145613 A1
(43) Pub. Date: Jun. 10, 2010

(54) APPARATUS FOR GENERATING LOCATION INFORMATION BASED ON WEB MAP AND METHOD THEREOF

(75) Inventors: Jongho Won, Daejeon-city (KR); Changseok Bae, Daejeon-city (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon-City (KR)

(21) Appl. No.: 12/614,557

(22) Filed: Nov. 9, 2009

(30) Foreign Application Priority Data
Dec. 5, 2008 (KR) 10-2008-0123469
Sep. 22, 2009 (KR) 10-2009-0089688

(51) Int. Cl. G01C 21/00; G06F 3/048

(52) U.S. Cl. 701/208; 715/862

(57) ABSTRACT

An apparatus for generating location information based on a web map includes a location information extracting unit that extracts the location information on the web map corresponding to each spot selected depending on movement of a pointer for searching the location information of the web map on the web map, which is received from a web map information storage server storing the web map and a location data generating unit that generates location data by using the location information extracted by the location information extracting unit. According to above, a system for generating location information based on a web map can provide an environment where various located-based services can be developed without an actual physical device in order to develop a service utilizing the location information.

### RELATED APPLICATIONS

The present application claims priority to Korean Patent Application Serial Number 10-2008-0123469, filed on Dec. 5, 2008 and Korean Patent Application Serial Number 10-2009-089688, filed on Sep. 22, 2009, the entirety of which is hereby incorporated by reference.

### BACKGROUND OF THE INVENTION

1. Field of the Invention

The present invention relates to an apparatus for generating location information based on a web map and a method thereof, and more particularly, to an apparatus for generating location information based on a web map and a method thereof which can provide accurate and various location information in order to develop a location-based service and verify the developed service in the state where the Internet is connected without a physical location information acquiring device.

2. Description of the Related Art

A global positioning system (GPS) which was developed for a military purpose in an initial stage begins to be applied to a private sector. In recent years, the GPS has been applied to various location-based application service fields, such as vehicle and personal navigation services, an object position tracking service, etc.

A means for continuously providing accurate location information is required to develop various location-based application services and verify the developed services.

In order to develop a location-based service utilizing the GPS or verify the developed service, actual location information should be presently acquired and used by attaching the physical GPS.

Further, due to a limitation in which the GPS cannot be used indoor due to its own characteristic, inspection of a service developed by previously collecting location information required to develop the location-based service and using only the collection information should be performed.

### SUMMARY OF THE INVENTION

In order to solve the above-mentioned problem, an object of the present invention is to provide an apparatus for generating location information based on a web map and a method thereof which provide accurate location information based on information actually acquired from a satellite in link with a web map service.

Further, another object of the present invention is to provide an apparatus for generating location information based on a web map and a method thereof which can be applied to more various location-based services by providing a speed and a moving distance of a moving object utilizing information on a moving speed or a moving trajectory of a pointer device such as a mouse that circulates the web map in order to continuously provide the location information of the moving object.

In order to achieve the above-mentioned object, an apparatus for generating location information based on a web map according to an aspect of the present invention includes a communication unit that receives the web map by accessing a web map information storage server storing the web map; a display unit that displays the web map received by the communication unit and a pointer for searching location information of the web map; a location information extracting unit that extracts the location information on the web map corresponding to each spot selected depending on movement of the pointer; and a location data generating unit that generates location data by using the location information extracted by the location information extracting unit.

The location information extracting unit requests web map information of a corresponding spot to the web map storage server through the communication unit depending on the movement of the pointer in real time and extracts location information from the web map information provided from the web map storage server.

The location information extracting unit includes a location coordinate generating module that extracts coordinate information on a latitude and a longitude of a spot on the web map where the pointer is located; a moving distance generating module that calculates a moving distance corresponding to the movement of the pointer on the web map on the basis of the coordinate information extracted by the location coordinate generating module; and a moving speed generating module that calculates moving speed corresponding to the movement of the pointer on the web map on the basis of the moving distance information calculated by the moving distance generating module.

The location coordinate generating module generates a moving trajectory on the web map on the basis of the extracted coordinate information.

The moving distance generating module calculates the moving distance of the pointer and calculates a moving distance on the web map corresponding to the calculated moving distance of the pointer.

The moving speed generating module calculates the moving speed of the pointer and calculates moving speed on the web map corresponding to the calculated moving speed of the pointer.

The apparatus for generating location information based on a web map further includes a random number generating unit that generates a random number for generating additional information on the spot on the web map where the pointer is located.

The location data generating unit generates location data by combining the location information extracted by the location information extracting unit and the additional information generated by using the random number.

The apparatus for generating location information based on a web map further includes a location information storage unit that stores the location information extracted by the location information extracting unit and the location data generated by the location data generating unit.

Meanwhile, in order to achieve the above-mentioned object, a method for generating location information based on a web map according to another aspect of the present invention includes receiving the web map by accessing a web map information storage server storing the web map; detecting movement of a pointer when the pointer for searching the location information on the received web map moves; extracting the location information on the web map corresponding to each spot selected depending on movement of the pointer; and generating location data by using the extracted location information.

The extracting includes extracting coordinate information on a latitude and a longitude of a spot on the web map where the pointer is located.

The method for generating location information based on a web map further includes generating a moving trajectory on the web map on the basis of the extracted coordinate information.

The extracting further includes calculating a moving distance depending on the movement of the pointer; and calculating a moving distance on the web map corresponding to the moving distance of the pointer on the basis of the coordinate information of the spot on the web map where the pointer is located.

The extracting further includes calculating moving speed depending on the movement of the pointer; and calculating moving speed on the web map corresponding to the moving speed of the pointer on the basis of the calculated moving distance information on the web map.

The extracting requests web map information of the corresponding spot depending on the movement of the pointer to the web map storage server in real time and extracts the location information from the web map information provided from the web map storage server.

The method for generating location information based on a web map further includes generating a random number for generating additional information on the spot on the web map where the pointer is located.

The generating generates the location data by combining the location information extracted in the extracting and the additional information generated by using the random number.

The method for generating location information based on a web map further includes storing or transferring the location data generated in the generating to the outside.

According to an embodiment of the present invention, it is possible to provide more accurate location information by generating location data based on information actually acquired from a satellite in link with a web map service based on the Internet.

Further, it is possible to apply an apparatus for generating location information based on a web map and a method thereof to more various location-based services by providing a speed and a moving distance of a moving object utilizing information on a moving speed or a moving trajectory of a pointer device such as a mouse that circulates the web map in order to continuously provide the location information of the moving object.

### BRIEF DESCRIPTION OF THE DRAWINGS

FIG. 1 is a diagram showing a system configuration to which an apparatus for generating location information based on a web map is applied according to the present invention;

FIG. 2 is a block diagram showing a configuration of an apparatus for generating location information based on a web map according to the present invention;

FIG. 3 is a block diagram showing a detailed module configuration of a location information extracting unit of FIG. 2;

FIG. 4 is a block diagram showing a detailed module configuration of a random number generating unit of FIG. 2;

FIG. 5 is a block diagram showing a detailed module configuration of a location data generating unit of FIG. 2;

FIG. 6 is a block diagram showing a detailed module configuration of a communication unit of FIG. 2; and

FIG. 7 is a flowchart showing an operational flow of a method for generating location information based on a web map according to the present invention.

### DETAILED DESCRIPTION OF THE PREFERRED EMBODIMENTS

Hereinafter, a configuration of the present invention will be described with reference to embodiments of the accompanying drawings.

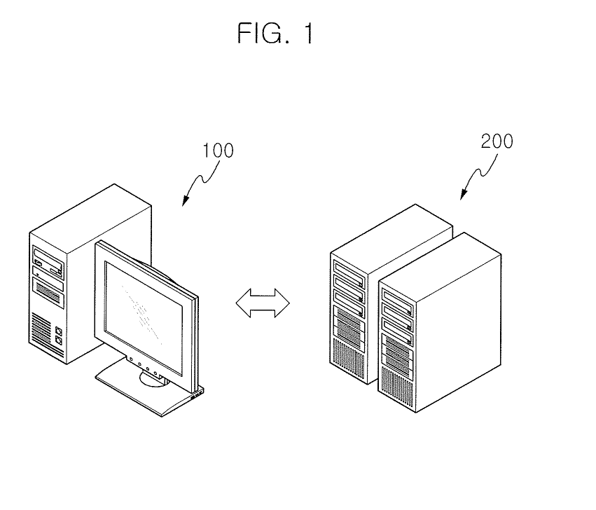

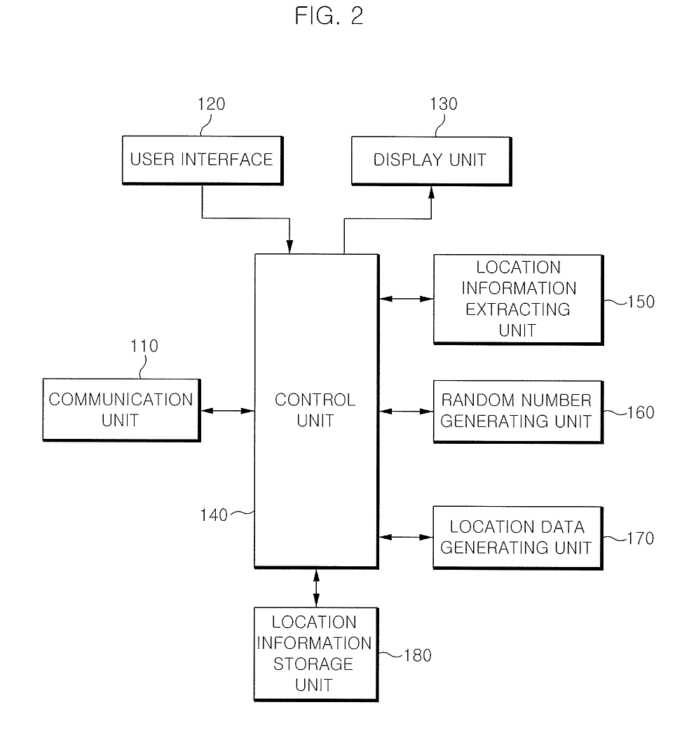

FIG. 1 is a diagram showing a system configuration to which an apparatus for generating location information based on a web map is applied according to the present invention and FIG. 2 is a block diagram showing a configuration of an apparatus for generating location information based on a web map according to the present invention.

Referring to FIGS. 1 and 2, the web map-based location information generating apparatus 100 according to the present invention requests web map data of a predetermined area in accordance with a user's request by accessing a web map storage server 200 in which the web map data is stored. At this time, the location information generating apparatus 100 receives the web map data requested from the web map storage server 200 and displays the web map data on a screen, and generates the location information as a pointer moves.

Hereinafter, referring to FIG. 2, the configuration of the location information generating apparatus 100 will be described.

As shown in FIG. 2, the location information generating apparatus 100 according to the present invention includes a communication unit 110, a user interface 120, a display unit 130, a control unit 140, a location information extracting unit 150, a random number generating unit 160, a location data generating unit 170, and a location information storage unit 180.

First, the communication unit 110 supports a communication interface so as to access the web. The communication unit 110 receives predetermined web map data from the web map storage server 200 by accessing the web map storage server 200 in accordance with a request of the control unit 140.

Meanwhile, the user interface 120 includes a keyboard, a mouse, etc. A user inputs a control command through the user interface 120 or controls movement of a pointer displayed on a screen of the display unit 130.

The display unit 130 displays a state depending on an operation of the location information generating apparatus 100 on the screen.

The control unit 140 controls operations of the communication unit 110, the user interface 120, the display unit 130, the location information extracting unit 150, the random number generating unit 160, the location data generating unit 170, and the location information storage unit 180.

The location information extracting unit 150 extracts location information of a spot indicated by the pointer on the web map provided from the web map data. At this time, the location information extracting unit 150 extracts location coordinate information, that is, latitude information and longitude information of the pointer moving on the web map by using a pointing device such as the mouse.

Further, the location information extracting unit 150 calculates a moving distance and moving speed of the pointer by using the extracted location coordinate information.

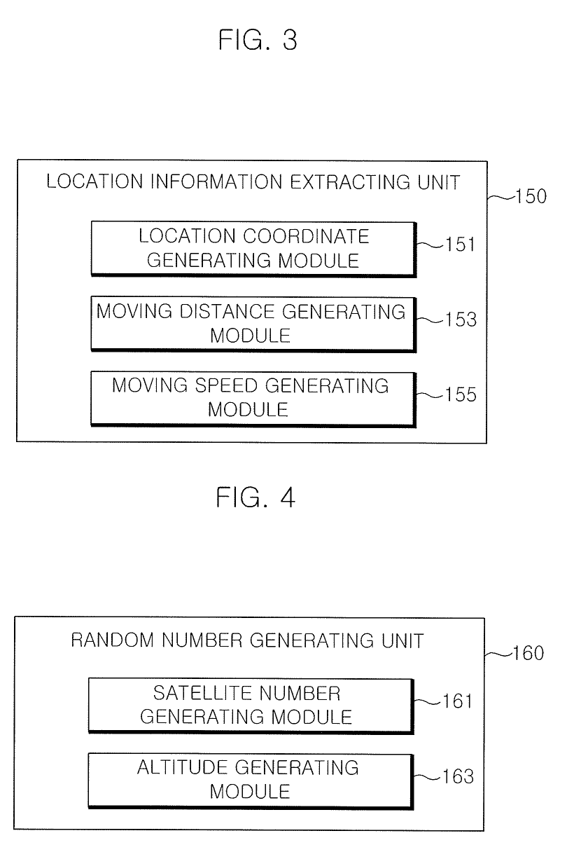

A detailed module configuration of the location information extracting unit 150 will be described with reference to FIG. 3.

The random number generating unit 160 generates a random number for information not included in the location information extracted by the location information extracting unit 150. In other words, the random number generating unit 160 generates a random number for information that is not provided from the web map storage server 200 or not extracted by the location information extracting unit 150. At this time, the random number generating unit 160 generates different random numbers depending on a usage purpose or characteristics of the corresponding information.

A detailed module configuration of the random number generating unit 160 will be described with reference to FIG. 4.

The location data generating unit 170 generates location data having a predetermined type by using the location information extracted from the location information extracting unit 150 and the random number generated by the random number generating unit 160.

At this time, the generation type of the location data may be defined by the user in advance. Of course, the location data generating unit 170 generates location data having different types depending on the usage purpose.

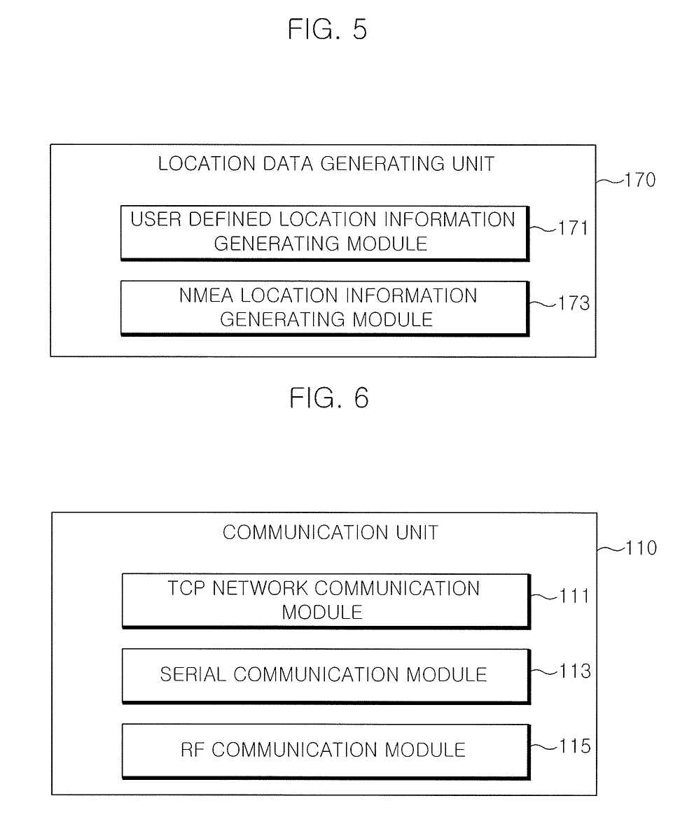

A detailed module configuration of the location data generating unit 170 will be described with reference to FIG. 5.

Meanwhile, the location data generated by the location data generating unit 170 is stored in the location information storage unit 180 or the generated location data is transferred to the outside through the communication unit 110 in accordance with a user's request. Of course, afterwards, the location data stored in the location information storage unit 180 may be transmitted to the outside.

Herein, the communication unit 110 is provided with a communication module for transferring the location data.

A detailed module configuration of the communication unit 110 will be described with reference to FIG. 6.

FIG. 3 is a block diagram showing the detailed module configuration of the location information extracting unit 150 of FIG. 2. Referring to FIG. 3, the location information extracting unit 150 according to the present invention includes a location coordinate generating module 151, a moving distance generating module 153, and a moving speed generating module 155.

When the web map data received from the web map storage server 200 is displayed on the screen of the display unit 130, the pointer on the screen moves in accordance with the signal inputted through the user interface 120.

At this time, the location coordinate generating module 151 detects the movement of the pointer moving on the screen of the display unit 130 and extracts the latitude and longitude information of a spot on the web map where the pointer is located.

The location coordinate generating module 151 extracts the latitude and longitude information of each spot where the pointer moves on the screen of the display unit 130. Herein, the latitude and longitude information corresponding to the web map are provided from the web map storage server 200.

Meanwhile, the location coordinate generating module 151 generates a movement trajectory on the web map on the basis of the extracted coordinate information.

The moving distance generating module 153 calculates a moving distance depending on the movement of the pointer.

Further, the moving distance generating module 153 calculates a moving distance corresponding to the movement of the pointer on the web map on the basis of the location coordinate information extracted by the location coordinate generating module 151.

In other words, when the moving distance of the pointer is 10 cm, a moving distance on the web map corresponding to the moving distance of the pointer is calculated.

At this time, the moving distance generating module 153 calculates a moving distance of the pointer every movement of the pointer by receiving the location coordinate information from the location coordinate generating module 151 in real time.

The moving speed generating module 153 calculates moving speed corresponding to movement of the pointer on the web map by using the location coordinate information extracted by the location coordinate generating module 151 and the moving distance information calculated by the moving distance generating module 153.

At this time, the moving speed generating module 155 calculates the moving speed of the pointer and calculates the moving speed on the web map corresponding to the moving speed of the pointer.

The moving speed generating module 155 calculates moving speed of the pointer depending on the movement of the pointer by receiving the corresponding information from the location coordinate generating module 151 and the moving distance generating module 153 in real time.

FIG. 4 is a block diagram showing a detailed module configuration of the random number generating unit 160 of FIG. 2.

Referring to FIG. 4, the random number generating unit 160 generates a random number for generating additional information on the spot where the pointer is located as described above.

Herein, the additional information generates a random number for information that is not provided by the web map storage server 200 or information that is not extracted by the location information extracting unit 150. For example, the additional information includes the number of detected satellites, an altitude, etc.

At this time, the random number generating unit 160 includes a satellite number generating module 161 and an altitude generating module 163.

The satellite number generating module 161 is a module that generates a random number for the detected satellite.

Meanwhile, the altitude generating module 163 generates a random number for an altitude of a spot where the pointer is located.

Herein, the random numbers generated by the satellite number generating module 161 and the altitude generating module 163 are transferred to the location data generating unit 170 through the control unit 140 and used to generate the location data.

FIG. 5 is a block diagram showing a detailed module configuration of the location data generating unit 170 of FIG. 2.

Referring to FIG. 5, the location data generating unit 170 includes a user defined location information generating module 171 and an NMEA location information generating module 173.

The user defined location information generating module 171 defines a configuration of location information used in a location-based service and generates the location information in accordance with the defined configuration.

The NMEA location information generating module 173 generates GPS data of the NMEA 0183 protocol which is the standard of an interface protocol of marine equipments.

Herein, the NMEA 0183 mainly referred to as NMEA is the specification for transmitting information including time, location, orientation, etc. The data are mainly in a gyrocompass, a GPS, a compass, an inertial navigation system (INS), etc.

The NMEA location information generating module 173 may be constituted by the entirety or a part of the module depending on the usage purpose thereof and may include a module that configure location information of another type and generates the location information.

FIG. 6 is a block diagram showing a detailed module configuration of the communication unit 110 of FIG. 2.

Referring to FIG. 6, the communication unit 110 receives the web map data from the web map storage server 200 by accessing the web map storage server 200. The communication unit 110 transfers the received web map data to the control unit 140, which is stored in the location information storage unit 180.

Meanwhile, the communication unit 110 performs a function to transfer the location data generated by the location data generating unit 170 to the outside.

Herein, the communication unit 110 includes a TCP network communication module 111, a serial communication module 113, and an RF communication module 115.

The TCP network communication module 111 as a module that controls information transmission of a network by using a transmission control protocol (TCP) divides messages or files into smaller packets and transmits the divided packets through the Internet and reassembles the received packets to the original message.

The serial communication module 113 transmits data in a unit of one bit at once through a communication channel or a computer bus by recording the location data in a serial port for serial communication of a type in which a physical GPS device is connected.

The RF communication module 115 as a module that transmits the location data through RF-based wireless communication such as Bluetooth, etc. transmits the received data loaded on a carrier frequency and extracts data loaded on the carrier frequency from a signal received from the outside. The RF communication module 115 may be constituted by the entirety or only a part of the module depending on the usage purpose thereof and may include a new-type transmission module.

Therefore, when the control unit 140 intends to transmit location data stored in the location information storage unit 180 to the outside, the control unit 140 transmits the corresponding location data to the outside by using at least one of communication modules provided in the communication unit 110.

An operational flow of the present invention configured as above will be described below.

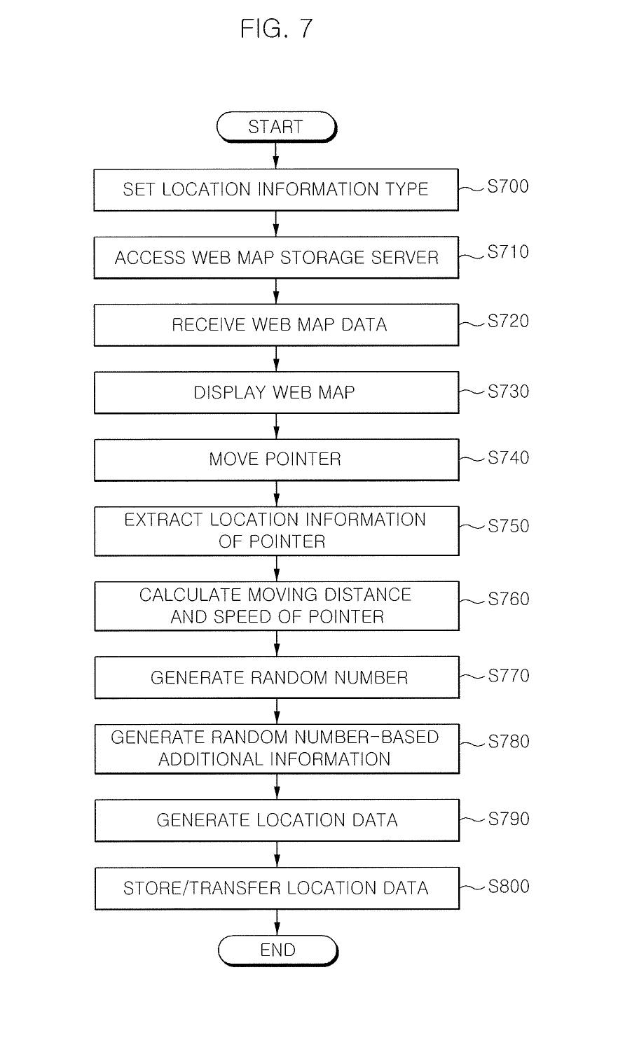

FIG. 7 is a flowchart showing an operational flow of a method for generating location information based on a web map according to an embodiment of the present invention.

As shown in FIG. 7, the method for generating location information based on a web map according to the embodiment of the present invention includes setting the type of location information generated by a web map-based location information generating apparatus 100 (S700), accessing a web map storage server 200 (S710), and receiving web map data (S720). Herein, the location information generating apparatus 100 can receive web map information corresponding to a corresponding area from the web map storage server 200 in real time in accordance with a request thereof.

The location information generating apparatus 100 calls the web map data received at step ‘S720’ and displays the web map (S730) and searches an area of which location information will be acquired while moving a pointer on the web map (S740).

At this time, location information of the corresponding pointer is extracted whenever the pointer moves (S750).

At step ‘S750’, latitude and longitude information of the area where the corresponding pointer is located are extracted on the basis of web map information provided from the web map storage server 200.

Further, when the pointer moves, a moving distance of the pointer is calculated by comparing a current location of the pointer with a previous location of the pointer on the basis of the location information calculated at step ‘S750’ and moving speed is calculated by using the calculated moving distance (S760).

Meanwhile, besides the information calculated at steps ‘S750’ and ‘S760’, a random number for additional information to be added to configure the location information is generated. At this time, the additional information is generated based on the generated random number (S770).

The location information generating apparatus 100 generates final location data by integrating the information acquired at steps ‘S750’ to ‘S770’ (S790) and stores or transmits the generated location data to the outside (S800).

As described above, an apparatus for generating location information based on a web map and a method thereof according to an embodiment of the present invention are not limited to the configuration and method of the embodiments described as above, but the embodiments may be configured by selectively combining all the embodiments or some of the embodiments so that various modifications can be made.

What is claimed is:

1. An apparatus for generating location information based on a web map, comprising:
a communication unit that receives the web map by accessing a web map information storage server storing the web map;
a display unit that displays the web map received by the communication unit and a pointer for searching location information of the web map;
a location information extracting unit that extracts the location information on the web map corresponding to each spot selected depending on movement of the pointer; and
a location data generating unit that generates location data by using the location information extracted by the location information extracting unit.

2. The apparatus for generating location information based on a web map according to claim 1, wherein the location information extracting unit requests web map information of a corresponding spot to the web map storage server through the communication unit depending on the movement of the pointer in real time and extracts location information from the web map information provided from the web map storage server.

3. The apparatus for generating location information based on a web map according to claim 1, wherein the location information extracting unit includes:
a location coordinate generating module that extracts coordinate information on a latitude and a longitude of a spot on the web map where the pointer is located;
a moving distance generating module that calculates a moving distance corresponding to the movement of the pointer on the web map on the basis of the coordinate information extracted by the location coordinate generating module; and
a moving speed generating module that calculates moving speed corresponding to the movement of the pointer on the web map on the basis of the moving distance information calculated by the moving distance generating module.

4. The apparatus for generating location information based on a web map according to claim 3, wherein the location coordinate generating module generates a moving trajectory on the web map on the basis of the extracted coordinate information.

5. The apparatus for generating location information based on a web map according to claim 3, wherein the moving distance generating module calculates the moving distance of the pointer and calculates a moving distance on the web map corresponding to the calculated moving distance of the pointer.

6. The apparatus for generating location information based on a web map according to claim 3, wherein the moving speed generating module calculates the moving speed of the pointer and calculates moving speed on the web map corresponding to the calculated moving speed of the pointer.

7. The apparatus for generating location information based on a web map according to claim 1, further comprising:
a random number generating unit that generates a random number for generating additional information on the spot on the web map where the pointer is located.

8. The apparatus for generating location information based on a web map according to claim 7, wherein the location data generating unit generates location data by combining the location information extracted by the location information extracting unit and the additional information generated by using the random number.

9. The apparatus for generating location information based on a web map according to claim 1, further comprising:
a location information storage unit that stores the web map information and the location data generated by the location data generating unit by accessing the web map information storage server.

10. A method for generating location information based on a web map, comprising:
receiving the web map by accessing a web map information storage server storing the web map;
detecting movement of a pointer when the pointer for searching the location information on the received web map moves;
extracting the location information on the web map corresponding to each spot selected depending on movement of the pointer; and
generating location data by using the extracted location information.

11. The method for generating location information based on a web map according to claim 10, the extracting includes extracting coordinate information on a latitude and a longitude of a spot on the web map where the pointer is located.

12. The method for generating location information based on a web map according to claim 11, further comprising:
generating a moving trajectory on the web map on the basis of the extracted coordinate information.

13. The method for generating location information based on a web map according to claim 11, wherein the extracting further includes:
calculating a moving distance depending on the movement of the pointer; and
calculating a moving distance on the web map corresponding to the moving distance of the pointer on the basis of the coordinate information of the spot on the web map where the pointer is located.

14. The method for generating location information based on a web map according to claim 11, wherein the extracting further includes:
calculating moving speed depending on the movement of the pointer; and
calculating moving speed on the web map corresponding to the moving speed of the pointer on the basis of the calculated moving distance information on the web map.

15. The method for generating location information based on a web map according to claim 10, wherein the extracting requests web map information of the corresponding spot depending on the movement of the pointer to the web map storage server in real time and extracts the location information from the web map information provided from the web map storage server.

16. The method for generating location information based on a web map according to claim 10, further comprising:
generating a random number for generating additional information on the spot on the web map where the pointer is located.

17. The method for generating location information based on a web map according to claim 16, wherein the generating generates the location data by combining the location information extracted in the extracting and the additional information generated by using the random number.

18. The method for generating location information based on a web map according to claim 10, further comprising:
storing or transferring the location data generated in the generating to the outside.
